(19) United States
(12) Patent Application Publication
(10) Pub. No.: US 2016/0042686 A1
(43) Pub. Date: Feb. 11, 2016

(54) ORGANIC LIGHT EMITTING DISPLAY

(71) Applicant: EverDisplay Optronics (Shanghai) Limited, Shanghai (CN)

(72) Inventor: Yu-Hsiung FENG, Shanghai (CN)

(21) Appl. No.: 14/536,627

(22) Filed: Nov. 9, 2014

(30) Foreign Application Priority Data
Aug. 6, 2014 (CN) 201410384214.3

(51) Int. Cl. G09G 3/32; G09G 3/20

(52) U.S. Cl. CPC G09G 3/3225; G09G 3/2003; G09G 2310/08

(57) ABSTRACT

An organic light emitting display includes a light emitting control circuit and display units. The light emitting control circuit outputs light emitting control signals that are independent from each other, in response to clock signals. An enable period of each one of the light emitting control signals is determined by at least one of a frequency and a duty ratio of a corresponding dock signal of the dock signals. The display units receive the light emitting control signals, respectively, and display the corresponding pixel data, respectively, according to the light emitting control signs.

### RELATED APPLICATIONS

This application claims priority to China Patent Application Serial Number 201410384214.3, filed Aug. 6, 2014, which is herein incorporated by reference.

### BACKGROUND

1. Technical Field

The present disclosure relates to a display apparatus. More particularly, the present disclosure relates to an organic light emitting display.

2. Description of Related Art

In conventional art, organic light emitting displays (OLED) may be substantially grouped into passive matrix organic light emitting displays (passive matrix OLED) and active matrix organic light emitting displays (active matrix OLED). Compared to the passive matrix organic light emitting displays, the active matrix organic light emitting displays have advantages such as low power loss, low operation voltage and high efficiency. Therefore, the active matrix organic light emitting displays become a mainstream of development for the organic light emitting displays nowadays.

In an active matrix organic light emitting display, driving signals are usually generated through gate lines to control ON/OFF state of pixels, and control signals are generated to drive light emitting devices in the pixels to emit light, through related circuits, so as to perform display operations.

Typically, for operations within a single frame period, in a period of writing voltage into a pixel, a light emitting control signal is disabled and fails to drive the light emitting device to emit light; outside the period of writing voltage into the pixel, the light emitting control signal is basically enabled to drive the light emitting device to emit light, and for all of pixel data, enable periods of corresponding light emitting control signals are the same. However, since a duration of the light emitting device driven to emit light in the entire frame period is very long, not only the duration of the light emitting device emitting light is wasted, causing power loss, but also a lifetime of the light emitting device is affected.

### SUMMARY

An aspect of the present disclosure is related to an organic light emitting display. The organic light emitting display includes a light emitting control circuit and a plurality of display units. The light emitting control circuit is configured to output a plurality of light emitting control signals that are independent from each other, in response to a plurality of clock signals, in which an enable period of each one of the plurality of light emitting control signals is determined by at least one of a frequency and a duty ratio of a corresponding clock signal of the plurality of clock signals. The plurality of display units are configured to receive the plurality of light emitting control signals and configured to respectively display corresponding pixel data according to the plurality of light emitting control signals.

Another aspect of the present disclosure is related to an organic light emitting display. The organic light emitting display includes a plurality of shift register units and a plurality of display units. The plurality of shift register units are configured to convert a plurality of clock signals to a plurality of light emitting control signals that are independent from each other, respectively, in which enable periods of the plurality of light emitting control signals correspond to pixel data of different colors and are adjustable. Each one of the plurality of display units includes a light emitting device and a pixel circuit. The pixel circuit is configured to drive the light emitting device to emit light, according to a corresponding light emitting control signal of the plurality of light emitting control signals.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of various embodiments, with reference to the accompanying drawings as follows:

FIG. 1 is a schematic diagram of an organic light emitting display according to some embodiments of the present disclosure;

FIG. 2 is a schematic diagram of the display unit illustrated in FIG. 1 according to some embodiments of the present disclosure;

FIG. 3 is a schematic diagram of the display unit illustrated in FIG. 1, according to further embodiments of the present disclosure;

FIG. 4 is a schematic diagram of the light emitting control circuit illustrated in FIG. 1, according to some embodiments of the present disclosure;

FIG. 5 is a schematic diagram of the light emitting control signals illustrated in FIG. 4, according to some embodiments of the present disclosure; and

FIG. 6 is a schematic diagram of the shift register units in FIG. 4, according to some embodiments of the present disclosure.

### DETAILED DESCRIPTION

In the following description, specific details are presented to provide a thorough understanding of the embodiments of the present disclosure. Persons of ordinary skill in the art will recognize, however, that the present disclosure can be practiced without one or more of the specific details, or in combination with other components. Well-known implementations or operations are not shown or described in detail to avoid obscuring aspects of various embodiments of the present disclosure.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

It will be understood that in the present disclosure, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

As used herein, the terms “comprising,” “including,” “having,” “containing,” “involving,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

In a conventional organic light emitting display (OLED), for operations within a single frame period, since a duration of a light emitting device driven to emit light in the entire frame period is very long, most part of the light emitting operation is wasted. As can be known from a driving principle for cathode ray tube (CRT), a duration of electron beam adopted to excite fluorescent powder is quite short, but human eyes fail to be aware of discontinuous frames or flickers because persistence of vision would be generated naturally for retina of the human eye in view of light.

Based on the aforementioned descriptions, the aforementioned effect of persistence of vision and afterglow effect resulted from the operation of the light emitting device emitting light are mainly employed in the present disclosure, by adjusting and shortening the duration of the light emitting device emitting light, such that image frame seen by the human eye is substantially the same. Specific embodiments are illustrated below.

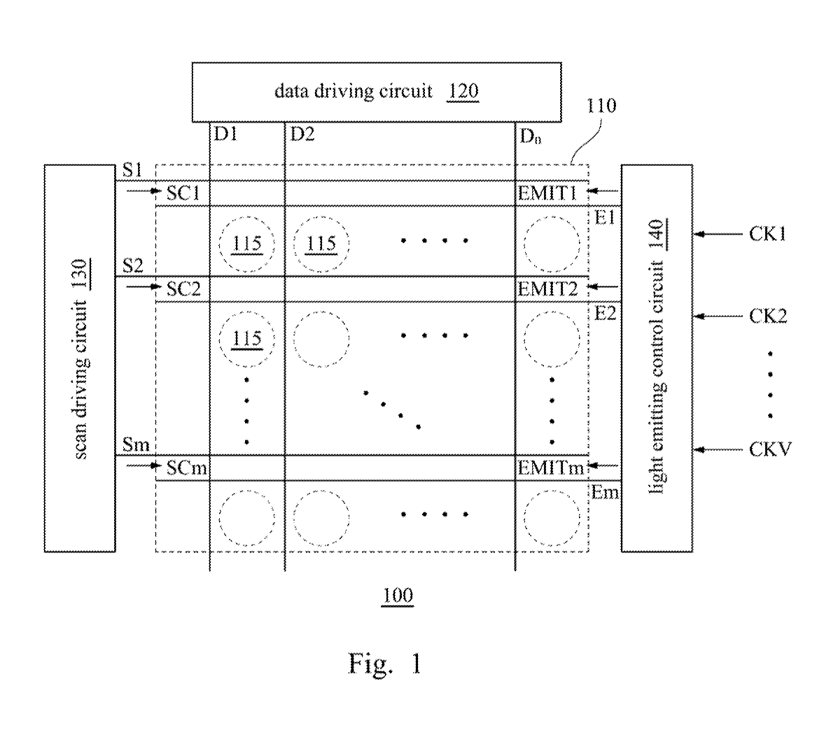

FIG. 1 is a schematic diagram of an organic light emitting display according to some embodiments of the present disclosure. As illustrated in FIG. 1, the organic light emitting display 100 includes a display panel 110, a data driving circuit 120, a scan driving circuit 130 and a light emitting control circuit 140. The display panel 110 includes data lines D1-Dn, scan lines S1-Sm, control lines E1-Em, and display units 115, in which m and n are positive integers. The data driving circuit 120 is electrically connected to the data lines D1-Dn, and configured to transmit data signals through the data lines D1-Dn to the display units 115, respectively. The scan driving circuit 130 is electrically connected to the scan lines S1-Sm, and configured to transmit scan signals SC1-SCm through the scan lines S1-Sm to the display units 115, respectively. The light emitting control circuit 140 is electrically connected to the control lines E1-Em, and configured to transmit light emitting control signals EMIT1-EMITm through the control lines E1-Em to the display units 115, respectively. Moreover, the display units 115 are disposed in areas defined by the data lines D1-Dn and the scan lines S1-Sm, respectively.

The light emitting control circuit 140 is mainly configured to output the light emitting control signals EMIT1-EMITm that are independent from each other, in response to clock signals CK1-CKV. The display units 115 are configured to receive the light emitting control signals EMIT1-EMITm through the control lines E1-Em, respectively, and respectively display corresponding pixel data according to the light emitting control signals EMIT1-EMITm. An enable period of each one of the light emitting control signals EMIT1-EMITm is determined by at least one of a frequency and a duty ratio of a corresponding clock signal of the clock signals CK1-CKV. In some embodiments, the light emitting control signals EMIT1-EMITm correspond to pixel data of different colors, respectively. In other words, enable periods of the light emitting control signals EMIT1-EMITm can correspond to pixel data of different colors to be adjustable, in which the enable period of each one of the light emitting control signals EMIT1-EMITm can be determined by the frequency or the duty ratio of the corresponding clock signal, or can be determined by the frequency together with the duty ratio of the corresponding clock signal as well.

As a result, the frequencies and/or the duty ratios of the clock signals can be controlled in order to achieve an object of controlling the enable periods of the light emitting control signals, such that in the entire frame period the duration of the light emitting device driven to emit light can be shortened, thus avoiding power loss, and the lifetime of the light emitting device can further be extended.

In some embodiments, the light emitting control signals EMIT1-EMITm are configured at low level state in their enable periods, and the clock signals CK1-CKV are configured at high level state in their enable periods, and in the condition that the duty ratios of the clock signals CK1-CKV are increased, the enable periods of the light emitting control signals EMIT1-EMITm are correspondingly shortened.

In some other embodiments, in the condition that the frequencies of the clock signals CK1-CKV are increased, the enable periods of the light emitting control signals EMIT1-EMITm are correspondingly shortened.

As a result, the frequencies and/or the duty ratios of the clock signals can be controlled in order to achieve an object of controlling the enable periods of the light emitting control signals. Illustratively, variations of the enable periods of the light emitting control signals EMIT1-EMITm, corresponding to the frequencies or the duty ratios of the clock signals CK1-CKV, are given for Illustrative purposes and not limiting of the present disclosure, and thus one of ordinary skill in the art can realize various embodiments of the light emitting control signals EMIT1-EMITm corresponding to the clock signals CK1-CKV, within the spirit and scope of the appended claims.

In practice, the scan driving circuit 130 and the light emitting control circuit 140 can be separately disposed, or integrated in a same circuit, according to practical needs. Therefore, the dispositions of the scan driving circuit 130 and the light emitting control circuit 140 illustrated in FIG. 1 are given for Illustrative purposes and not limiting of the present disclosure.

Illustratively, the “enable period” described in the present disclosure is mainly indicative of a signal enabling period in which any one of the light emitting control signals EMIT1-EMITm is configured for driving the light emitting devices in the display units 115 to emit light, and thus it also can be termed as “light emitting period.” Furthermore, according to the aforementioned illustrations, the light emitting control signals EMIT1-EMITm that are different from each other correspond to the pixel data of different colors and are transmitted to the corresponding display units 115, respectively. Therefore, the arrangements of the control lines E1-Em and the display units 115 illustrated in FIG. 1 are given for Illustrative purposes and not limiting of the present disclosure.

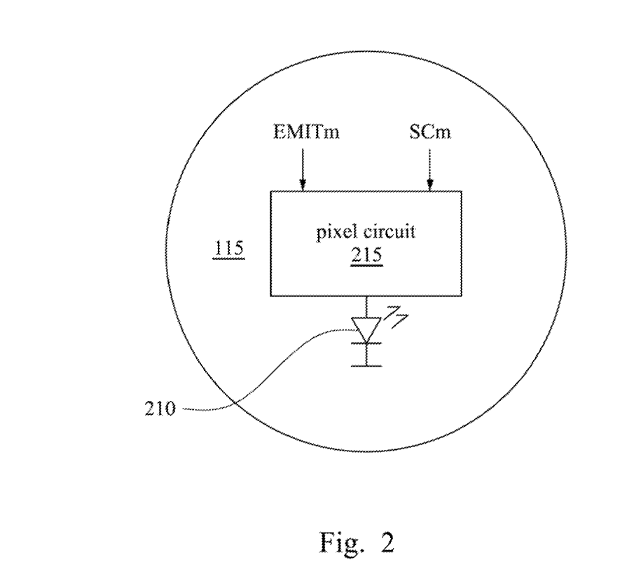

FIG. 2 is a schematic diagram of the display unit 115 illustrated in FIG. 1, according to some embodiments of the present disclosure. As illustrated in FIG. 2, the display unit 115 includes a light emitting device 210 and a pixel circuit 215, in which the pixel circuit 215 is configured to receive the corresponding scan signal SCm and the corresponding light emitting control signal EMITm, and configured to drive the light emitting device 210 to emit light according to the corresponding light emitting control signal EMITm, such that the display unit 115 can display the corresponding pixel data.

In practice, the enable period of the light emitting control signal EMITm can be determined by a practical light emitting efficiency of the light emitting device 210, in which a higher light emitting efficiency represents that a required duration of emitting light is relatively shorter (herein it may be referred under a condition with fixed light emitting area). On the other hand, ratios of the emitted light of different colors, that are required for forming the white light, are different, and thus if the control operations cannot be performed based on the light emitting area, the control operations still can be performed by adjusting the enable period of the light emitting control signal EMITm.

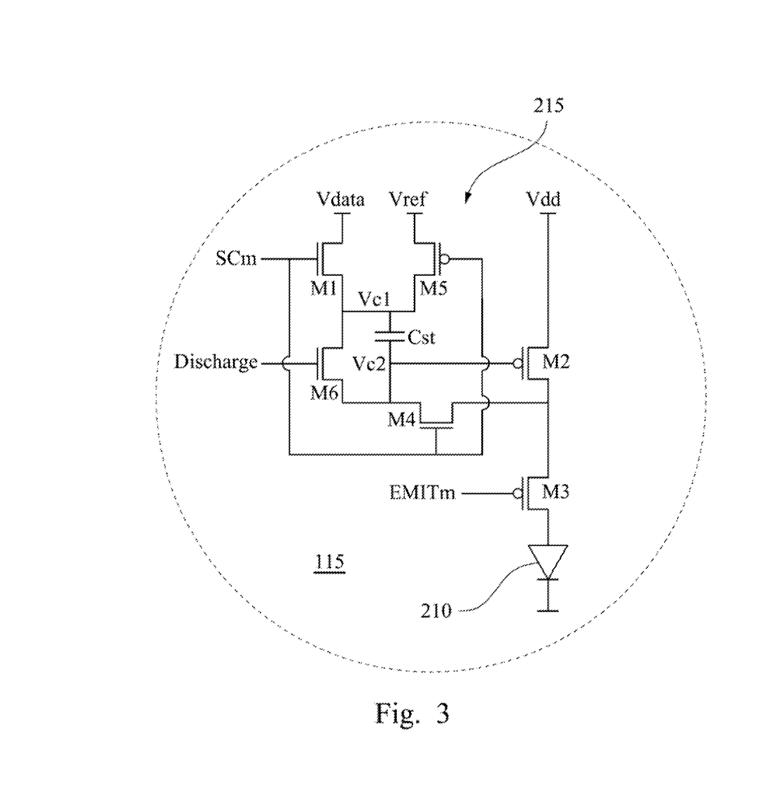

FIG. 3 is a schematic diagram of the display unit 115 illustrated in FIG. 1, according to further embodiments of the present disclosure. Compared to the embodiments illustrated in FIG. 2, the pixel circuit 215 can include switch devices M1-M6 and a capacitor Cst, i.e., so-called 6T1C pixel circuit structure, in which connections of the switch devices M1-M6 and the capacitor Cst are configured as illustrated in FIG. 3. In operation, in the enable period of the light emitting control signal EMITm, the switch device M3 is switched on by the light emitting control signal EMITm, such that the light emitting device 210 is thus driven to emit light, and the display unit 115 display the corresponding pixel data accordingly.

Illustratively, the structure of the pixel circuit 215 illustrated in FIG. 3 is given as one embodiment and not limiting of the present disclosure. Therefore, one of ordinary skill in the art can adopt various pixel circuits with different structures according to practical needs.

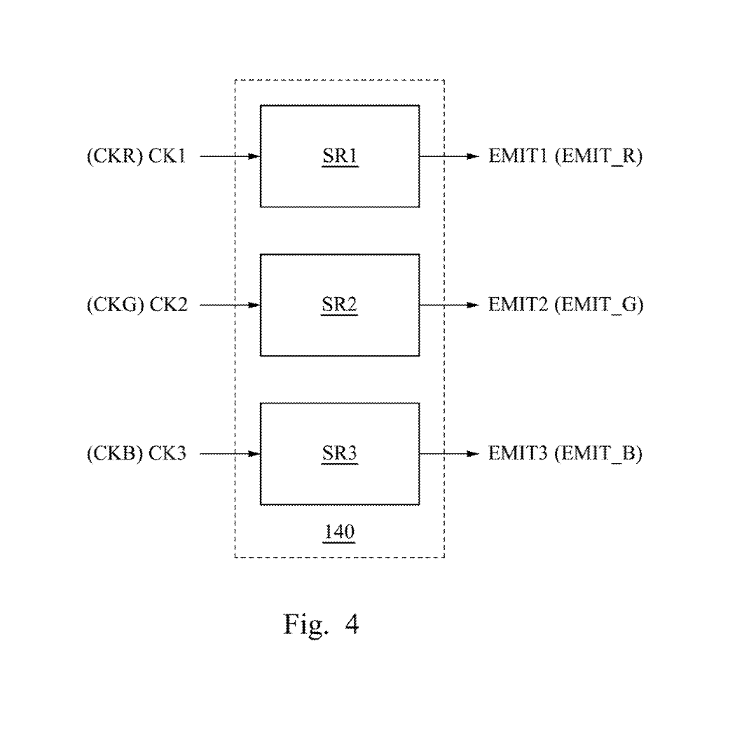

FIG. 4 is a schematic diagram of the light emitting control circuit 140 illustrated in FIG. 1, according to some embodiments of the present disclosure. As illustrated in FIG. 4, the light emitting control circuit 140 can include a plurality of shift register units (e.g., shift register units SR1, SR2, SR3), and the shift register units are configured to convert a plurality of clock signals (e.g., the clock signals CK1, CK2, CK3) to the light emitting control signals (e.g., the light emitting control signals EMIT1, EMIT2, EMIT3) that are independent from each other, respectively.

Illustratively, for convenience of illustration, the shift register units SR1, SR2, SR3 are illustrated and described with reference to FIG. 4, but the number of the shift register units is not limited to the embodiments illustrated in FIG. 4, and the number of the shift register units mainly correspond to the number of the display units 115 illustrated in FIG. 1. In other words, in some embodiments, the light emitting control circuit 40 can include several shift register units, in which a part of the shift register units transmit the light emitting control signals to the display units 115 displaying red pixel data, a part of the shift register units transmit the light emitting control signals to the display units 115 displaying green pixel data, and a part of the shift register units transmit the light emitting control signals to the display units 115 displaying blue pixel data.

Based on the aforementioned descriptions, in some embodiments, the light emitting control signal EMIT1 can be a light emitting control signal EMIT_R corresponding to the red pixel data, the light emitting control signal EMIT2 can be a light emitting control signal EMIT_G corresponding to the green pixel data, the light emitting control signal EMITS can be a light emitting control signal EMIT_B corresponding to the blue pixel data, and the enable periods of the light emitting control signals EMIT_R, EMIT_G and EMIT_B can be adjustable corresponding to the pixel data.

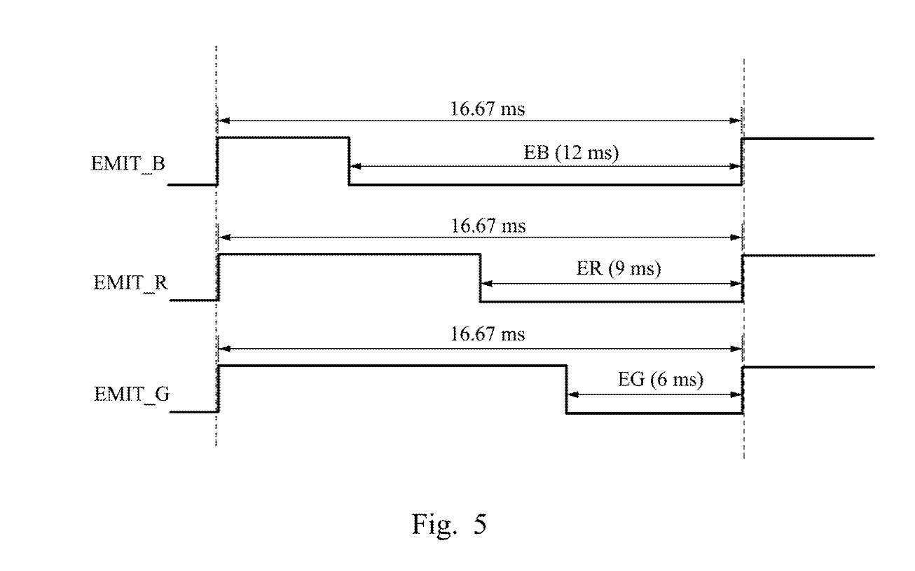

In further embodiments, the enable periods of at least two of the light emitting control signals EMIT_R, EMIT_G and EMIT_B are different from each other. FIG. 5 is a schematic diagram of the light emitting control signals EMIT_R, EMIT_G and EMIT_B illustrated in FIG. 4, according to some embodiments of the present disclosure. As illustrated in FIG. 5, for operations within a single frame period (e.g., 16.67 millisecond), the light emitting control signals EMIT_B, EMIT_R and EMIT_G correspond to the blue, red and green pixel data, respectively, in which an enable period EB of the light emitting control signal EMIT_B is longer than an enable period ER of the light emitting control signal EMIT_R, and the enable period ER of the light emitting control signal EMIT_R is longer than an enable period EG of the light emitting control signal EMIT_G. For example, the enable period EB of the light emitting control signal EMIT_B can be 12 millisecond, the enable period ER of the light emitting control signal EMIT_R can be 9 millisecond, and the enable period EG of the light emitting control signal EMIT_G can be 6 millisecond.

Furthermore, in other embodiments, the clock signals CK1, CK2, CK3 received by the light emitting control circuit 140 in FIG. 4 are independent from each other, and at least two of the clock signals CK1, CK2, CK3 are different from each other. As illustrated in FIG. 4, the clock signals CK1, CK2, CK3 can be clock signals CKR, CKG, CKB corresponding to the red, green and blue pixel data, respectively, and different from each other; that is, the clock signals CKR, CKG, CKB can be adjustable corresponding to different pixel data, respectively.

In further embodiments, at least one of the frequency and the duty ratio of any one of the clock signals CK1, CK2, CK3 (or CKR, CKG, CKB) is adjustable. For example, the frequency or the duty ratio of the clock signal CK1 (or CKR) can be adjusted according to the corresponding pixel data, or the frequency together with the duty ratio of the clock signal CK1 (or CKR) can be adjusted according to the corresponding pixel data. As a result, in the condition that the clock signals CK1, CK2, CK3 (or CKR, CKG, CKB) are already adjusted, the corresponding light emitting control signals EMIT1, EMIT2, EMIT3 (or EMIT_B, EMIT_R and EMIT_G) outputted by the light emitting control circuit 140 also can be adjusted, so as to further adjust the light emitting operations of the light emitting device 210.

Based on the aforementioned descriptions, in some embodiments, the enable period of each one of the light emitting control signals EMIT1, EMIT2, EMIT3 (or EMIT_B, EMIT_R and EMIT_G) can be determined by at least one of the frequency and the duty ratio of a corresponding clock signal of the clock signals CK1, CK2, CK3 (or CKR, CKG, CKB).

As a result, the light emitting durations of the light emitting devices in the display units can be controlled respectively by independent light emitting control signals corresponding to the blue, red and green pixel data, such that effect of the persistence of vision is maximized to achieve the result of saving power.

Furthermore, the control of light emitting durations can be determined by a control signal outputted by an integrated circuit (IC), and thus gamma curves corresponding to luminescence brightness of pixels with different colors can be adjusted correspondingly, such that the driving IC is not required to be changed and is able to be applied in various organic light emitting displays, further improving the time interval of developing products significantly.

On the other hand, the shift register unit SR1, SR2, or SR3 in FIG. 4 further can output several light emitting control signals according to the corresponding clock signals. Specific explanations are made in the following illustration.

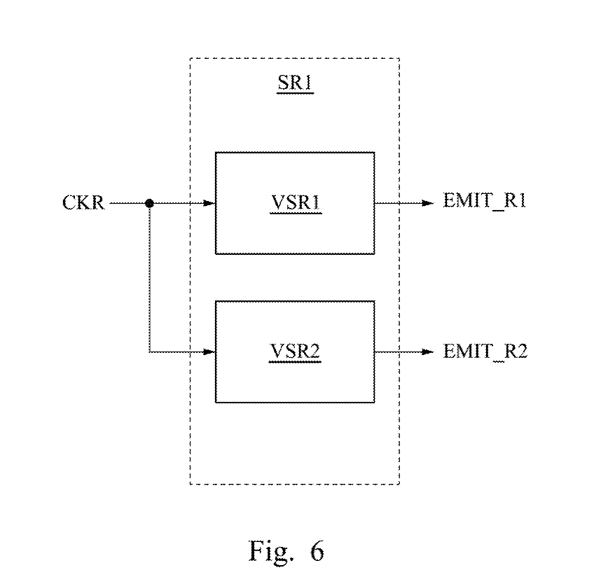

FIG. 6 is a schematic diagram of the shift register units in FIG. 4 according to some embodiments of the present disclosure. For convenience of illustration only the shift register unit SR1 is illustrated in FIG. 6, but it is not limited thereto; that is, the concept of the embodiments illustrated in FIG. 6 can be applied in other shift register units.

As illustrated in FIG. 6, the shift register unit SR1 can include shift registers VSR1 and VSR2, and the shift registers VSR1 and VSR2 are configured to convert the corresponding clock signal CKR to light emitting control signals EMIT_R1 and EMIT_R2, respectively, such that the light emitting devices in the corresponding display units perform light emitting operations according to the light emitting control signals EMIT_R1 and EMIT_R2, respectively. In practice, the shift registers VSR1 and VSR2 can be vertical shift registers, but they are not limited thereto.

Illustratively, the enable periods of the light emitting control signals EMIT_R1 and EMIT_R2 can be the same or different. Furthermore, the number of the shift registers mentioned above is not limited to the embodiments illustrated in FIG. 6, and the number of the shift registers mainly correspond to the number of the display units 115 illustrated in FIG. 1.

As can be known from the aforementioned embodiments of the present disclosure, the aforementioned organic light emitting displays can be applied in order for advantages as below
1. the duration of the light emitting device emitting light can be shortened, and the lifetime of the light emitting device can be extended significantly;
2. the light emitting durations corresponding to the red, green and blue pixel data can be adjusted inside the driving. IC, such that the use of the driving IC is more convenient;
3. since the light emitting durations can be adjusted, degradation of organic light emitting material, generated due to long-time use, can be compensated (mainly because degradation levels of pixels with different colors are different).

The operations are not necessarily recited in the sequence in which the steps are performed. That is, unless the sequence of the operations is expressly indicated, the sequence of the operations is interchangeable, and all or part of the operations may be simultaneously, partially simultaneously, or sequentially performed.

As is understood by one of ordinary skill in the art, the foregoing embodiments of the present disclosure are illustrative of the present disclosure rather than limiting of the present disclosure. It is intended to cover various modifications and similar arrangements included within the spirit and scope of the appended claims, the scope of which should be accorded with the broadest interpretation so as to encompass all such modifications and similar structures.

What is claimed is:

1. An organic light emitting display comprising:
a light emitting control circuit configured to output a plurality of light emitting control signals that are independent from each other, in response to a plurality of clock signals, wherein an enable period of each one of the plurality of light emitting control signals is determined by at least one of a frequency and a duty ratio of a corresponding clock signal of the plurality of clock signals; and
a plurality of display units configured to receive the plurality of light emitting control signals and configured to respectively display corresponding pixel data according to the plurality of light emitting control signals.

2. The organic light emitting display as claimed in claim 1, wherein the light emitting control circuit comprises:
a plurality of shift register units configured to convert the plurality of clock signals to the plurality of light emitting control signals, respectively, wherein the plurality of light emitting control signals at least comprise a first light emitting control signal corresponding to red pixel data, a second light emitting control signal corresponding to green pixel data, and a third light emitting control signal corresponding to blue pixel data.

3. The organic light emitting display as claimed in claim 2, wherein enable periods of at least two of the plurality of light emitting control signals are different from each other.

4. The organic light emitting display as claimed in claim 2, wherein the plurality of shift register units are configured to receive the plurality of clock signals that are independent from each other, and at least one of a frequency and a duty ratio of any one of the plurality of clock signals is adjustable.

5. The organic light emitting display as claimed in claim 2, wherein at least two of the plurality of clock signals are different from each other, and at least two of enable periods of the plurality of light emitting control signals are different from each other.

6. The organic light emitting display as claimed in claim 2, wherein enable periods of at least two of the plurality of light emitting control signals are adjustable corresponding to pixel data of different colors.

7. The organic light emitting display as claimed in claim 1, wherein the light emitting control circuit is configured to receive the plurality of clock signals that are independent from each other, and at least one of a frequency and a duty ratio of any one of the plurality of clock signals is adjustable.

8. The organic light emitting display as claimed in claim 1, wherein at least two of the plurality of clock signals are different from each other, and at least two of enable periods of the plurality of light emitting control signals are different from each other.

9. The organic light emitting display as claimed in claim 1, wherein enable periods of at least two of the plurality of light emitting control signals are adjustable corresponding to pixel data of different colors.

10. The organic light emitting display as claimed in claim 1, wherein enable periods of the plurality of light emitting control signals are adjustable, and a frequency and a duty ratio of each one of the plurality of clock signals are adjustable.

11. An organic light emitting display comprising:
a plurality of shift register units configured to convert a plurality of clock signals to a plurality of light emitting control signals that are independent from each other, respectively, wherein enable periods of the plurality of light emitting control signals correspond to pixel data of different colors and are adjustable; and
a plurality of display units, each one of the plurality of display units comprises:
a light emitting device; and
a pixel circuit configured to drive the light emitting device to emit light, according to a corresponding light emitting control signal of the plurality of light emitting control signals.

12. The organic light emitting display as claimed in claim 11, wherein an enable period of each one of the plurality of light emitting control signals is determined by at least one of a frequency and a duty ratio of a corresponding clock signal of the plurality of clock signals.

13. The organic light emitting display as claimed in claim 11, wherein the plurality of light emitting control signals comprise a first light emitting control signal corresponding to red pixel data, a second light emitting control signal corresponding to green pixel data, and a third light emitting control signal corresponding to blue pixel data, and enable periods of at least two of the first light emitting control signal, the second light emitting control signal and the third light emitting control signal are different from each other.

14. The organic light emitting display as claimed in claim 13, wherein the plurality of shift register units are configured to receive the plurality of clock signals that are independent from each other, and at least one of a frequency and a duty ratio of any one of the plurality of clock signals is adjustable.

15. The organic light emitting display as claimed in claim 13, wherein the plurality of clock signals are different from each other, and a frequency and a duty ratio of each one of the plurality of clock signals is adjustable.

16. The organic light emitting display as claimed in claim 11, wherein the plurality of shift register units are configured to receive the plurality of clock signals that are independent from each other, and at least one of a frequency and a duty ratio of any one of the plurality of clock signals is adjustable.

17. The organic light emitting display as claimed in claim 11, wherein at least two of the plurality of clock signals correspond to pixel data of different colors to be different from each other, and enable periods of at least two of the plurality of light emitting control signals correspond to pixel data of different colors to be different from each other.

18. The organic light emitting display as claimed in claim 11, wherein the plurality of shift register units are configured to receive the plurality of clock signals that are different from each other and are adjustable corresponding to pixel data of different colors, and an enable period of each one of the plurality of light emitting control signals is determined by at least one of a frequency and a duty ratio of a corresponding clock signal of the plurality of clock signals.

19. The organic light emitting display as claimed in claim 11, wherein the plurality of light emitting control signals at least comprise a first light emitting control signal corresponding to red pixel data, a second light emitting control signal corresponding to green pixel data, and a third light emitting control signal corresponding to blue pixel data, and enable periods of the first light emitting control signal, the second light emitting control signal and the third light emitting control signal are adjustable corresponding to the red, green and blue pixel data, respectively, and the enable periods of the first light emitting control signal, the second light emitting control signal and the third light emitting control signal are determined by corresponding clock signals of the plurality of clock signals.
